(19) United States
(12) Patent Application Publication
(10) Pub. No.: US 2010/0250490 A1
(43) Pub. Date: Sep. 30, 2010

(54) Field Filtering

(75) Inventor: Ian Mcdowall, Cambridge (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/520,541

(22) PCT Filed: Dec. 21, 2007
(86) PCT No.: PCT/GB07/04939

§ 371 Date: Apr. 23, 2010

(30) Foreign Application Priority Data
Dec. 21, 2006 (GB) 0625643.2

(51) Int. Cl. G06F 17/30

(52) U.S. Cl. 707/634; 707/754; 707/E17.005; 707/E17.059

(57) ABSTRACT

A computing device capable of storing at least one set of data and communicating at least one stored set of data to another device during a data synchronisation operation, the computing device being arranged to determine that a stored data set includes filtered data that is not to be communicated to the other device during a data synchronisation operation, form synchronisation data from the stored data set by substituting the filtered data with an indicator, the indicator being such as to indicate the filtered data to the other device and communicate the synchronisation data to the other device during the data synchronisation operation.

The invention relates to a computing device that is capable of communicating its stored data with another device during a data synchronisation operation.

Computing devices include desktop and laptop computers, personal digital assistants (PDAs), mobile telephones, smartphones, digital cameras and digital music players. They also include converged devices incorporating the functionality of one or more of the classes of device already mentioned, together with many other industrial and domestic electronic appliances.

One key application for communication-centric computing devices, which rely for their utility on their ability to connect to other computer and telecommunications networks, is data synchronization (DS) by which the data held on one computing device can be made to match the data held on another computing device. For example, data synchronisation can be used to update a calendar on a mobile phone with new diary entries made on a laptop computer or to update a contacts list stored on a mobile phone with a new telephone number for a particular entry on the contacts list of a PDA. Since a data synchronisation operation is often performed by transferring data between different types of computing devices, a protocol known as the SyncML protocol has been developed to govern data synchronisation operations between different devices.

Within the domain of data synchronization, filtering can be used to reduce the volume of data transferred. Filtering permits some types of data to be synchronised but not other types. There are a number of possible reasons why this may be desirable or necessary. Reducing the data transferred can reduce transmission costs (where costs are based on the amount of data transferred) or transmission times. In addition, data synchronization clients may have significantly less storage capability than data synchronization servers. This disparity between server and client capacity is even more pronounced where the clients are mobile devices.

Filtering is typically performed at the field level, so that data relating to a particular field is not transferred during a data synchronisation operation. For example, a mobile phone may perform a data synchronisation operation with a laptop computer in which the laptop computer sends any changes or new entries to its contact list to the mobile phone but omits fax numbers from the synchronisation data. Filtering may be performed in only one direction of data transfer (e.g. the laptop filters the synchronisation data that it sends to the mobile phone but the mobile phone does not filter the data that it sends to the laptop) or may be performed on both directions of data transfer. Different filters may be applied in each direction.

In the examples given above filtering is used just to block some fields from being transferred during a data synchronisation operation. However, other filtering options are available. For example, an additional filtering option is soft deletion. Soft deletion can be used to delete a record from the sync client (thus saving space) while leaving it on the server (to allow later retrieval).

Existing filtering methods have some significant deficiencies.

First, if an optional field (such as an attachment) is filtered out there is no way to differentiate between a record without the field and a record with the field filtered out.

Second, soft deletion operates at the record level (in which deletion affects all of the data relating to a particular object) and not at the field level (in which some of the data relating to a particular object can be removed whilst leaving the remainder untouched). This means that if a bulky field is retrieved, which the sync client wants to delete locally while leaving it on the server, there is no way to inform the server that this has been done and that future synchronisation of the record should filter out the field.

Third, if a server is synchronizing data with multiple servers, soft deletion and field level filtering do not notify all the servers of the state of the client. For example, if one server sends a soft delete command to the client and the client deletes the indicated item then the client is unable to indicate to another server that the item has been soft deleted. It is therefore possible that the second server will send updates to the item to the client—thus undoing the soft delete.

A further problem is that since filtering data during data synchronisation operations is a relatively new technique, different clients and servers often have different filtering capabilities. Typically appropriate filters for a data synchronisation operation can be selected by the user of the device, e.g. through a sync configuration application or an application that uses a sync configuration application to restrict the amount of data transferred or to transfer only specific records or fields. However, while the applications of one device know which filters that device is capable of requesting, they typically do not know which filters the other device in the synchronisation operation is capable of providing.

Existing protocols allow filtering capabilities to be published. However, sync clients are normally required to specify the filters that they require from a server before receiving details of the server's filter capabilities. This is because sync clients typically initiate the sync sessions and the required filters are specified in the first message (e.g. in SyncML). By contrast, a server is likely (although not guaranteed) to receive the client's filtering capabilities before it specifies the filtering required.

A sync client should normally define the filters it requires from the server before the first synchronisation takes place. This avoids the transfer of too much data (with the associated cost and time delay). If a client requests filters that the server does not support then an error will be returned by the server.

Therefore, a further problem with existing filtering techniques is that a client is not aware of the filtering techniques supported by different servers before it requests a synchronisation session and must therefore request filters without knowing whether or not they are supported. The client must then handle the resultant server responses, including error messages.

Therefore, there is a need for computing devices with improved filtering capabilities.

According to a first aspect of the present invention there is provided a computing device capable of storing at least one set of data and communicating at least one set of stored data to another device during a data synchronisation operation, the computing device being arranged to: determine that a stored data set includes filtered data that is not to be communicated to the other device during a data synchronisation operation; form synchronisation data from the stored data set by substituting the filtered data with an indicator that indicates the filtered data; and communicate the synchronisation data to the other device during the data synchronisation operation.

The computing device may be arranged to substitute the filtered data with an indicator that identifies the filtered data to the other device.

The computing device is preferably capable of performing a filtering operation on a stored data set to reduce the amount of the computing device's memory occupied by the stored data set.

The indicator could identify a filtering operation performed on the data set.

The computing device could comprise a memory for storing the at least one set of data, the computing device being arranged to perform a filtering operation on a stored data set by identifying that the data set includes filtered data that is not to be communicated to the other device and by deleting that filtered data from the memory.

The computing device could be arranged to store a record of the deletion.

The other device may store a copy of the filtered data and the computing device is arranged to substitute the filtered data with an indicator that indicates to the other device that the filtered data should be included by the other device in synchronisation data communicated from the other device to the computing device during a subsequent data synchronisation operation.

The computing device could comprise a memory for storing the at least one set of data, the computing device being arranged to perform a filtering operation on a data set stored in the memory by identifying that the data set includes filtered data that is not to be communicated to the other device and by retaining that filtered data in the memory.

The filtering operation could be a delete operation. More specifically, it could be a delete operation wherein the filtered data is deleted from the memory of the computing device and retained in the memory of the other device.

The computing device could be arranged to replace the filtered data with an indicator that indicates to the other device that the filtered data should be deleted from the memory of the other device.

The computing device is optionally arranged to replace the filtered data with an indicator that indicates to the other device that the filtered data should be retained in the memory of the other device.

The computing device may be arranged to include the indicator in synchronisation data communicated to the other device during subsequent data synchronisation operations, or it could be arranged not to include the indicator in synchronisation data communicated to the other device during subsequent data synchronisation operations.

The computing device could be arranged to include the indicator in synchronisation data formed from the same filtered data set communicated to other devices during subsequent data synchronisation operations with those devices.

The computing device may be arranged to operate according to a protocol wherein the filtered data is indicated by an indicator of a predetermined format.

According to a second aspect of the present invention there is provided a computing device capable of storing at least one set of data and of updating that at least one set of data in dependence on data received from another device during a data synchronisation operation, the computing device being arranged to: receive synchronisation data from another device during a data synchronisation operation; determine that the synchronisation data includes an indicator indicating that the data set from which the synchronisation data was formed included filtered data that is not included in the synchronisation data; and update the stored at least one set of data in dependence on the synchronisation data.

The computing device could be arranged to identify from the indicator the filtered data that has not been included in the synchronisation data.

The computing device preferably comprises a memory for storing data, the computing device being arranged to modify the data stored in the memory in dependence on the indicator.

The computing device could be arranged to determine that it stores a copy of the data identified as being filtered data in the memory.

The computing device may be arranged to delete the copy of the data identified as being filtered data from the memory, or it may be arranged to retain the copy of the data identified as being filtered data in the memory.

The computing device could be arranged to form synchronisation data to be communicated to the other device during a subsequent data synchronisation operation in dependence on the indicator.

The computing device may be arranged to include the copy of the data identified as being filtered data in synchronisation data to be communicated to the other device during a subsequent data synchronisation operation.

The data set could be a record. The filtered data could be a field.

According to a third aspect of the present invention there is provided a computing device arranged to operate as a computing device as defined in the first aspect, and as a computing device as defined in the second aspect.

According to a fourth aspect of the invention there is provided a computer program arranged to control a computing device as defined above.

According to a fifth aspect of the invention there is provided an operating system arranged to control a computing device as defined above.

According to a sixth aspect of the invention there is provided a method of performing a data synchronisation operation for synchronising the data stored on two devices, the method comprising, in a first device: determining that set of data to be communicated to a second device during a data synchronisation operation includes filtered data that is not to be communicated to the second device during the data synchronisation operation; forming synchronisation data from the data set by substituting the filtered data with an indicator, the indicator being such as to indicate the filtered data to the second device; and communicating the synchronisation data to the second device during the data synchronisation operation.

According to a seventh aspect of the invention there is provided a computing device capable of communicating data with another device during a data synchronisation operation and of storing the capability of another device to filter data, the computing device being arranged to initiate a data synchronisation operation with another device in dependence on a stored filtering capability associated with that device.

The computing device is preferably arranged, if it has no filtering capability stored in respect of a device, not to initiate a data synchronisation operation with the device.

The computing device could be arranged to, if it has no filtering capability stored in respect of another device, request that other device's filtering capabilities from that other device.

The computing device may be arranged to request the other device's filtering capabilities in a request for a data synchronisation operation.

For a better understanding of the present invention, reference is made by way of example to the following drawings, in which:

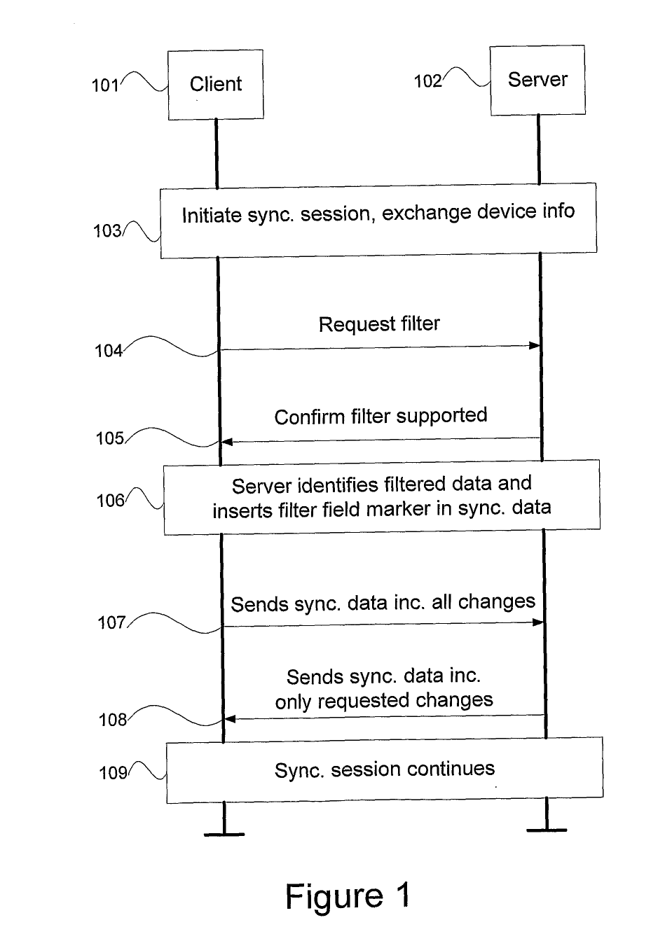

FIG. 1 shows a data synchronisation session in which a Field Filter Marker is included in the synchronisation data sent by the client;

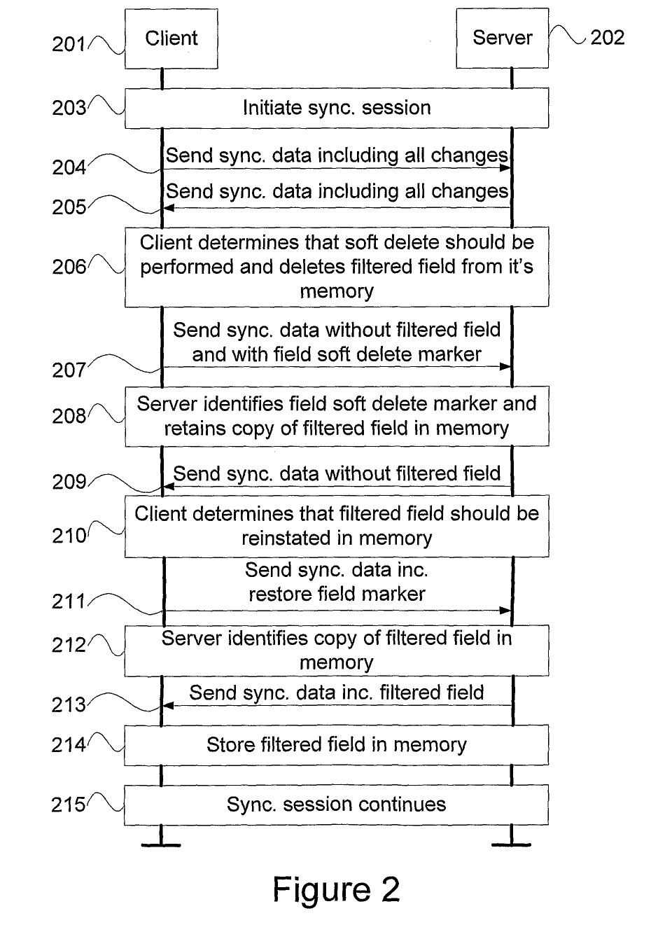

FIG. 2 shows a data synchronisation session in which a soft delete is initiated by the client;

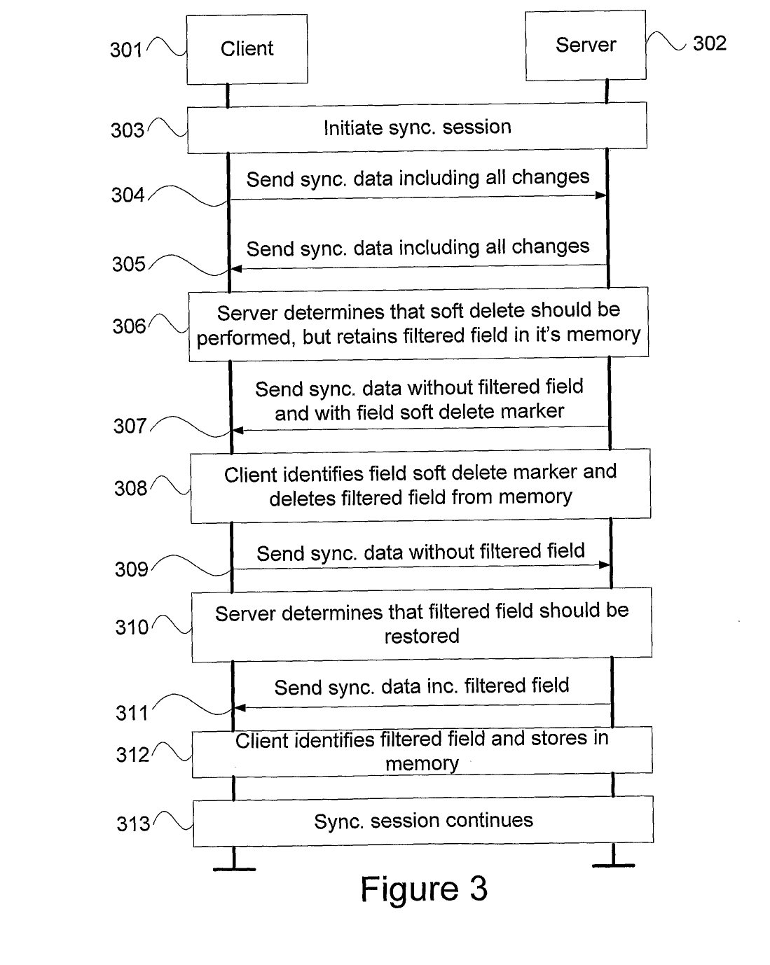

FIG. 3 shows a data synchronisation session in which a soft delete is initiated by the server;

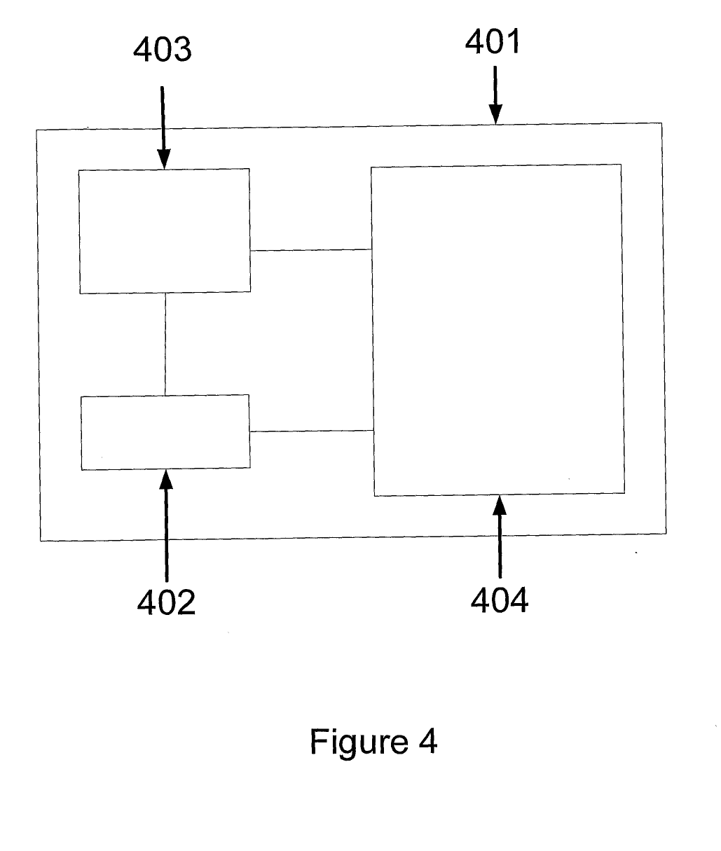

FIG. 4 shows a computing device according to certain embodiments of the invention; and

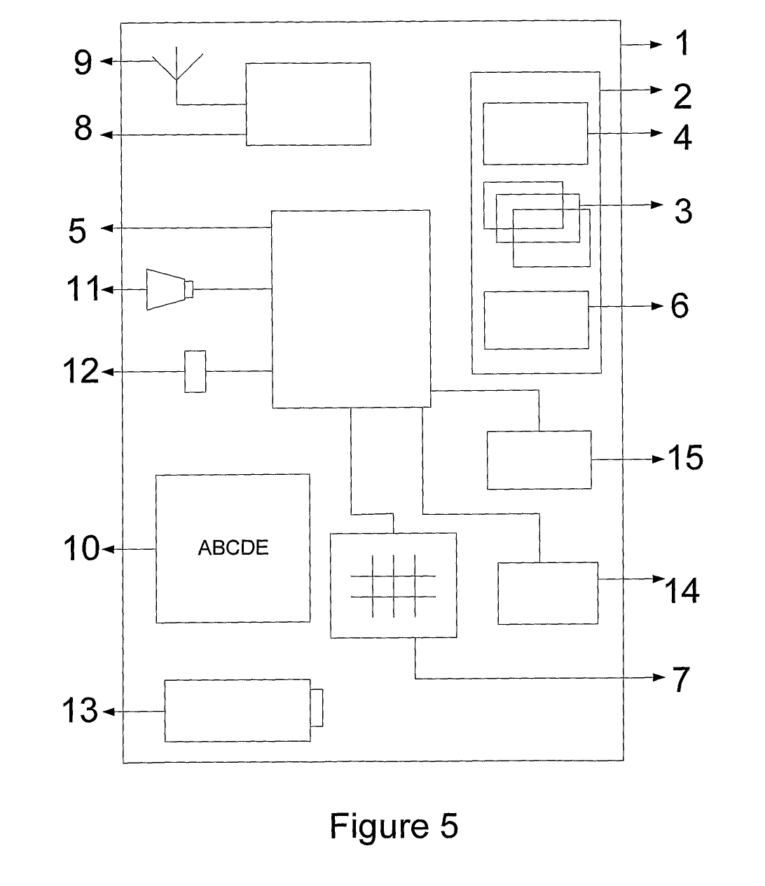

FIG. 5 shows a mobile phone capable of acting as a computing device according to certain embodiments of the invention.

A computing device according to certain embodiments of the invention is capable of storing at least one set of data and communicating the at least one set of data to another device during a data synchronisation operation. In order to minimise the amount of data transferred during the data synchronisation operation, the computing device may use a filter to determine which data should be transferred as synchronisation data and which data should not be transferred. The computing device is advantageously arranged to determine which data is filtered data (i.e. data that is not to be transferred during the synchronisation operation) and to form synchronisation data in which the filtered data is substituted by an indicator. The indicator informs the receiving device of the existence of the filtered data.

A computing device according to embodiments of the invention is advantageous because it can inform its partner device in a data synchronisation operation that some of the data, which would otherwise have been transferred, has been filtered out. The receiving device therefore knows that the filtered data did exist (at some point in time) on the sending device, but that it has been subject to a filtering operation. The computing device may also use different indicators according to which filtering operation it performed, so that the receiving device knows how the data was filtered prior to the data synchronisation operation and also what action (if any) it should take in respect of any copies of the filtered data that is has stored in its own memory.

Embodiments of the invention therefore provide a computing device that is able to communicate data to another device in an advantageous way during a synchronisation operation. However, the invention is also applicable to a computing device acting as the recipient device during a data synchronisation operation. Therefore, a computing device according to certain embodiments of the invention is capable of storing at least one set of data and of updating that at least one set of data in dependence on data received from another device during a data synchronisation operation. The computing device is advantageously arranged to determine that synchronisation data received from another device during a data synchronisation operation includes an indicator acting as a substitute for filtered data.

Specific embodiments of the invention will now be described in more detail with reference to various different indicators that may be included in synchronisation data, in particular, Field Filter Markers and Field Soft Delete Markers and Restore Markers.

Field Filter Markers

When a field is filtered out of a record, it may be replaced with an agreed Field Filter Marker value that indicates to the recipient that the field has been filtered out. The exact marker value does not matter as long it is agreed between the participants and as long as it cannot be confused with a legitimate, non-filtered, field value.

An example of a synchronisation session using a Field Filter Marker is shown in FIG. 1. The client 101 initiates a synchronisation session with a server 102 at 103. The two devices may exchange device information. The client requests a particular filter be applied by the server at 104. The server confirms that the filter is available at 105. The server then identifies any data which falls within the scope of the filter (i.e. data which should not be transferred to the client during a synchronisation operation) and inserts a filter field marker in the synchronisation data to indicate the filtered data to the client (106). The synchronisation session then continues in 107 and 108 with the client transferring synchronisation data including all changes and the server sending synchronisation data including only the requested changes (i.e. all changes except the filtered data). The synchronisation data sent by the server also includes the Field Filter Marker.

Preferably the client and server exchange synchronisation data that includes only the changes made to a record since the last synchronisation operation (i.e. the last time that the client and server exchanged synchronisation data), as shown in FIG. 1. However, the synchronisation data need not be limited to data changes if transferring unchanged records is beneficial for a particular implementation.

The Field Filter Marker may take a number of different forms. Where a record is encoded using a format that allows additional data to be associated with a field (such as a format, a type or a property parameter) the Field Filter Marker can be an extension of one of those types of information, so as to avoid confusion with field values. Where a record is not encoded in such a format, the Field Filter Marker may be an actual field value that is considered unlikely to occur in normal use. Alternatively, an additional field may be defined as a Field Filter Marker. This field may be included if a field has been filtered out so that the presence or absence of the marker field acts as the Field Filter Marker. With this solution, a separate marker field may be defined for each field that can be filtered (in which case the presence of the marker field is sufficient) or a single marker field may be defined to cover all filterable fields (in which case the content of the marker field must denote the fields that have been filtered out).

The Field Filter Marker may depend on the encoding format. A single format for the Field Filter Marker may not be agreed for all encoding formats.

Field Soft Delete Markers

When a sync server or sync client wants to soft delete a field, a Field Soft Delete Marker is sent in place of the field. This Field Soft Delete Marker value has the same constraints and options as the Field Filter Marker value described above. That is, it must be agreed between the client and the server and must be unambiguous. The exact form of the marker will depend on the encoding used.

If a server sends a Field Soft Delete Marker for a field to the client, the client should delete the contents of the field from the record but does not need to maintain any history of the soft deletion. However, it is preferred for the client to mark the field as soft deleted (or filtered out) so that the field can be retrieved at a later date. If the field is not marked as soft deleted, the client does not know that the field can be retrieved from the server.

An example of a synchronisation session using a Field Soft Delete Marker is shown in FIG. 2. The client 201 initiates a synchronisation session with a server 202 at 203. The client and server exchange synchronisation data including all changes at 204 and 205. The client then determines that a soft delete should be performed. It identifies the field to be deleted and deletes this field (the filtered field) from its memory (206). The client then sends synchronisation data including all changes except those relating to the filtered field and with a Field Soft Delete Marker substituted for the filtered field (207). The server identifies the Field Soft Delete Marker and the field to which it relates (208). Because the indicator is a Field Soft Delete Marker, the server knows that the identified field should be retained in memory so that it can later be restored in the memory of the client, if required. The server subsequently does not include the soft deleted field in synchronisation data transferred to the client (209).

A further example of a synchronisation session using a Field Soft Delete Marker is shown in FIG. 3. The client 301 initiates a synchronisation session with a server 302 at 303. The client and server exchange synchronisation data including all changes at 304 and 305. The server then determines that a soft delete should be performed. It identifies the field to be deleted, but retains this field (the filtered field) in its memory (306). The server then sends synchronisation data including all changes except those relating to the filtered field and with a Field Soft Delete Marker substituted for the filtered field (307). The client identifies the Field Soft Delete Marker and the field to which it relates (308). Because the indicator is a Field Soft Delete Marker, the client knows that the identified field should be deleted from memory. The client subsequently does not include the soft deleted field in synchronisation data transferred to the client (309).

In subsequent exchanges of the record with the soft deleted field, the field may be marked as soft deleted, although this is not required.

Subsequently, if it is desired to recover the soft deleted field, this can be done in one of two ways, as explained below.

Restore Markers

If the client wishes to recover a soft deleted field then it can synchronize the record with a Restore Marker in place of the field. The Restore Marker value has the same constraints and options as the Field Soft Delete Marker. If the server receives a record with the Restore Marker indicating that a soft deleted field should be reinstated then it should reply with the record including the restored field. This is shown in steps 210 to 215 of FIG. 2.

At 210 the client determines that the filtered field should be restored in memory and so during the next synchronisation operation it includes a Restore Field Marker in the synchronisation data (211). The server receives and identified the Restore Field Marker and finds its copy of the filtered field in memory (212). The server subsequently includes the filtered field to the client during the next synchronisation operation (213). The client stores the filtered field in memory (214) and the synchronisation session continues as before.

If the server wishes to reinstate a soft deleted field on a client (possibly because of a user interaction on the server or because the field data has changed) then it can simply send a record including the restored field. This is shown in steps 310 to 313 of FIG. 3.

At 310 the server determines that the filtered field should be restored to the client. At 311 the server sends synchronisation data to the client that includes the filtered field. The client updates its memory to include the synchronisation data (312) and the synchronisation session continues as before (313).

FIGS. 2 and 3 show two different methods of soft deleting a field and of restoring a soft deleted field. The exact sequence of events shown in these figures is for the purposes of example only and the events could be initiated variously by the client or server devices. For example, a client could initiate the soft delete (as shown in FIG. 2) followed by the server initiating the restoration of the filtered field (as shown in FIG. 3).

If the client received a record that includes data for a previously soft-deleted field then it should discard the Field Soft Delete Marker and treat the field as a normal field.

If a client is synchronizing the same data with multiple servers then marking the field as soft deleted (rather than simply deleting it after soft deletion) allows the client to inform all servers that the field should not be sent. For example, the client may substitute the filtered field for a Field Soft Delete Marker in data synchronisation operations with all servers.

The filtering techniques described above allow field filtering to be used more effectively that at present. At present, field level filtering is in its infancy. However, increasing uses of field filtering are envisaged together with looming problems. These anticipated problems are addressed by embodiments of the invention. Their use allows field level filtering (of which field soft delete is one aspect) to be truly useful and allows the amount of data synchronized to be tuned. This will help all forms of data synchronization but currently visible uses include email synchronization and calendar attachments.

Computing devices have may different filtering capabilities. Existing implementations have tended to focus on setting up client-server pairs with matching capabilities. However, it would be advantageous if clients and servers having different filtering capabilities were able to efficiently exchange data for data synchronisation purposes.

Because standardised filtering is relatively new and immature, client manufacturers have tended focused on ensuring that their client's inter-operate with specific sync servers. However, as sync clients are released into a heterogeneous market they will be exposed to sync servers that the client manufacturers have no control over and they will need to be able to respond dynamically to the different server capabilities. This is a problem that has not existed to date but will exist in the future.

A computing device according to certain embodiments of the invention may be capable of communicating data with another device during a data synchronisation operation and of storing the capability of another device to filter data communicated during a data synchronisation operation. The computing device is preferably arranged to initiate a data synchronisation operation with another device in dependence on the filtering capability that it has stored in respect of that device.

In existing implementations, the client initiates the synchronisation procedure and receives the server's filtering capabilities in response. The client is preferably arranged to store these filtering capabilities so that when it wants to perform a new synchronisation session with the server, it has that server's capabilities stored in memory and can decide whether or not to initiate a synchronisation session with the server in dependence on those stored capabilities. If the client does not have a stored copy of the server's filters then the following options are available for obtaining the required information.

As a first option, the client can publish its own capabilities and request the server's capabilities rather than triggering a sync in the first message. This allows the client to select its filters based on the server's capabilities, even in the first synchronisation performed using that server.

As a second option, the client can request all required and desired filters as well as requesting the server's filter capabilities and then handle any errors returned by the server. If the server returns an error indicating that some filters are not supported then the received filtering capabilities can be used to decide what action to take. If the filtering capabilities of the server are acceptable to the client then it can initiate a new synchronisation session.

The client should store the server's published filtering capabilities once they have been received, so that the stored capabilities can be used at a later date when deciding whether or not to initiate a synchronisation session with a server.

If the client has stored the server's filtering capabilities then the client may request only the filters that the server supports when initiating a synchronisation session. Unsupported filters can be ignored. This saves the client from having to handle error messages returned by the server when an unsupported filter is requested by the client.

The client may decide not to initiate a sync session with a particular server if that server does not support the required filters because initiating a synchronisation session with that server would lead to excessive data transfer. The user may be informed of this decision via the calling application.

The choice of behaviour can be configured to be the same for all filters. For example, the client could be configured to always drop unsupported filters and carry out the synchronisation regardless, or to always decline a synchronisation if the server does not support the required filters. Alternatively, the client's behaviour can be selected on a filter by filter basis. For example, the client could view some filters as mandatory and others as only desirable. If a mandatory filter is unsupported the client may decline to initiate a synchronisation session, whereas if a desirable filter is unsupported the client may decide to proceed with the synchronisation session regardless.

FIG. 5 shows an implementation of a computing device according to certain embodiments of the invention. The computing device 501 includes a communication unit 502, which is configured to handle data communications with another device, a memory unit 503 for storing data and a control unit 504 for controlling operations of the computing device. In particular, the control unit may be configured to control data synchronisation operations with another device, e.g. determining whether a synchronisation operation should be initiated with another device in dependence on data indicating the filtering capabilities of that device stored in the memory unit, determining that a record includes a filtered field and substituting that filtered field with an indicator to form synchronisation data that can then be passed to the communication unit for transferring to the other device and detecting an indicator in synchronisation data received from another device. The control unit may suitably be a digital processor acting under the control of an operating system.

FIG. 6 shows a mobile phone in which the filtering techniques according to certain embodiments of the invention may suitably be implemented. The mobile phone, shown generally at 1, includes a non-volatile memory 2 that stores instructions defining application programs (shown schematically at 3) and an operating system (shown schematically at 4). The mobile phone may be configured in such a way that the operating system controls the memory. The mobile phone has a CPU 5 which can execute the instructions stored in memory 2. The non-volatile memory also stores data (shown schematically at 6) defining a series of resource usage profiles. The mobile phone has a keypad 7 by which a user can control the operation of the phone. The mobile phone has an RF transceiver 8 coupled to an antenna 9, by means if which it can transmit and receive data according to a mobile phone radio protocol. The transceiver is coupled to the CPU. Data received by the transceiver is passed to the CPU and data can be passed from the CPU to the transceiver for transmission. The mobile phone has a display 10 for displaying data to a user, a loudspeaker 11 for producing sound (e.g. to reproduce audio data received through the transceiver 8) and a microphone 12 for receiving sound (e.g. to capture audio data that is subsequently to be transmitted by the transceiver 7). The mobile phone is powered by a battery 13. The mobile phone may be provided with a working memory, which may be on the CPU or in RAM (random access memory) 15 coupled to the CPU.

It should be understood that the devices operating as a “client” or as a “server” as described herein may perform these functions interchangeably. The terms “client” and “server” do not refer to any specific type or class of device. A computing device according to embodiments of the invention may act as a client device or as a server device.

There are a number of key application domains which feature strongly in the capabilities of many different types of computing devices and are familiar to many users. These include word processing, messaging, web browsing, data management, multimedia, games and personal information management (PIM) applications.

A synchronisation session may be one-way or two-way. If the synchronisation session is two-way, filters may be applied in both directions in a similar manner to that described herein. Different filters may be applied in one direction from the other direction.

Synchronisation data may be transferred between two devices via a wired or a wireless connection.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

1. A computing device capable of storing at least one set of data and communicating at least one set of stored data to another device during a data synchronisation operation, the computing device being arranged to:
determine that a stored data set includes filtered data that is not to be communicated to the other device during a data synchronisation operation;
form synchronisation data from the stored data set by substituting the filtered data with an indicator that indicates the filtered data; and
communicate the synchronisation data to the other device during the data synchronisation operation.

2. A computing device as claimed in claim 1, wherein the computing device is arranged to substitute the filtered data with an indicator that identifies the filtered data to the other device.

3. A computing device as claimed in any preceding claim, wherein the computing device is capable of performing a filtering operation on a stored data set to reduce the amount of the computing device's memory occupied by the stored data set.

4. A computing device as claimed in claim 3, wherein the indicator also identifies a filtering operation performed on the data set.

5. A computing device as claimed in claim 3 or 4, wherein the computing device comprises a memory for storing the at least one set of data, the computing device being arranged to perform a filtering operation on a stored data set by identifying that the data set includes filtered data that is not to be communicated to the other device and by deleting that filtered data from the memory.

6. A computing device as claimed in claim 5, wherein the computing device is arranged to store a record of the deletion.

7. A computing device as claimed in claim 5 or 6, wherein the other device stores a copy of the filtered data and the computing device is arranged to substitute the filtered data with an indicator that indicates to the other device that the filtered data should be included by the other device in synchronisation data communicated from the other device to the computing device during a subsequent data synchronisation operation.

8. A computing device as claimed in claim 3 or 4, wherein the computing device comprises a memory for storing the at least one set of data, the computing device being arranged to perform a filtering operation on a data set stored in the memory by identifying that the data set includes filtered data that is not to be communicated to the other device and by retaining that filtered data in the memory.

9. A computing device as claimed in any of claims 3 to 7, wherein the filtering operation is a delete operation.

10. A computing device as claimed in any of claims 3 to 9, wherein the filtering operation is a delete operation wherein the filtered data is deleted from the memory of the computing device and retained in the memory of the other device.

11. A computing device as claimed in any preceding claim, wherein the computing device is arranged to replace the filtered data with an indicator that indicates to the other device that the filtered data should be deleted from the memory of the other device.

12. A computing device as claimed in any of claims 1 to 10, wherein the computing device is arranged to replace the filtered data with an indicator that indicates to the other device that the filtered data should be retained in the memory of the other device.

13. A computing device as claimed in any preceding claim, wherein the computing device is arranged to include the indicator in synchronisation data communicated to the other device during subsequent data synchronisation operations.

14. A computing device as claimed in any preceding claim, wherein the computing device is arranged not to include the indicator in synchronisation data communicated to the other device during subsequent data synchronisation operations.

15. A computing device as claimed in any preceding claim, wherein the computing device is arranged to include the indicator in synchronisation data formed from the same filtered data set communicated to other devices during subsequent data synchronisation operations with those devices.

16. A computing device as claimed in any preceding claim, the computing device being arranged to operate according to a protocol wherein the filtered data is indicated by an indicator of a predetermined format.

17. A computing device capable of storing at least one set of data and of updating that at least one set of data in dependence on data received from another device during a data synchronisation operation, the computing device being arranged to:
receive synchronisation data from another device during a data synchronisation operation;
determine that the synchronisation data includes an indicator indicating that the data set from which the synchronisation data was formed included filtered data that is not included in the synchronisation data; and
update the stored at least one set of data in dependence on the synchronisation data.

18. A computing device as claimed in claim 17, wherein the computing device is arranged to identify from the indicator the filtered data that has not been included in the synchronisation data.

19. A computing device as claimed in claim 17 or 18, wherein the computing device comprises a memory for storing data, the computing device being arranged to modify the data stored in the memory in dependence on the indicator.

20. A computing device as claimed in claim 18 or claim 19 as dependent on claim 18, wherein the computing device is arranged to determine that it stores a copy of the data identified as being filtered data in the memory.

21. A computing device as claimed in claim 20, wherein the computing device is arranged to delete the copy of the data identified as being filtered data from the memory.

22. A computing device as claimed in claim 20, wherein the computing device is arranged to retain the copy of the data identified as being filtered data in the memory.

23. A computing device as claimed in any of claims 17 to 22, wherein the computing device is arranged to form synchronisation data to be communicated to the other device during a subsequent data synchronisation operation in dependence on the indicator.

24. A computing device as claimed in claim 23 as dependent directly or indirectly on 20, wherein the computing device is arranged to include the copy of the data identified as being filtered data in synchronisation data to be communicated to the other device during a subsequent data synchronisation operation.

25. A computing device as claimed in any of claims 1 to 24, wherein the data set is a record.

26. A computing device as claimed in any of claims 1 to 25, wherein the filtered data is a field.

27. A computing device arranged to operate as a computing device as claimed in any of claims 1 to 16 and as a computing device as claimed in any of claims 17 to 26.

28. A computer program arranged to control a computing device so as to operate as claimed in any of claims 1 to 27.

29. An operating system arranged to control a computing device so as to operate as claimed in any of claims 1 to 27.

30. A method of performing a data synchronisation operation for synchronising the data stored on two devices, the method comprising, in a first device:
determining that set of data to be communicated to a second device during a data synchronisation operation includes filtered data that is not to be communicated to the second device during the data synchronisation operation;
forming synchronisation data from the data set by substituting the filtered data with an indicator, the indicator being such as to indicate the filtered data to the second device; and
communicating the synchronisation data to the second device during the data synchronisation operation.

31. A computing device capable of communicating data with another device during a data synchronisation operation and of storing the capability of another device to filter data, the computing device being arranged to initiate a data synchronisation operation with another device in dependence on a stored filtering capability associated with that device.

32. A computing device as claimed in claim 31, wherein the computing device is arranged, if it has no filtering capability stored in respect of a device, not to initiate a data synchronisation operation with the device.

33. A computing device as claimed in claim 31 or 32, wherein the computing device is arranged to, if it has no filtering capability stored in respect of another device, request that other device's filtering capabilities from that other device.

34. A computing device as claimed in claim 33, wherein the computing device is arranged to request the other device's filtering capabilities in a request for a data synchronisation operation.

35. A computing device substantially as described herein with reference to the accompanying drawings.

36. An operating system substantially as described herein with reference to the accompanying drawings.

37. A method substantially as described herein with reference to the accompanying drawings.
